(19) United States
(12) Patent Application Publication
(10) Pub. No.: US 2026/0359508 A1
(43) Pub. Date: Nov. 12, 2026

(54) GENERATING ROBOTIC GRASPS FOR CAD MODELS

(71) Applicant: Autodesk, Inc., San Francisco, CA (US)

(72) Inventors: Yash Sandeep Shukla, Waltham, MA (US); Srinidhi Bharadwaj Kalgundi Srinivas, San Francisco, CA (US); Sachin Chitta, Palo Alto, CA (US); Adam Noble Arnold, Berkeley, CA (US)

(21) Appl. No.: 19/314,891

(22) Filed: Aug. 29, 2025

Related U.S. Application Data
(60) Provisional application No. 63/804,486, filed on May 12, 2025.

(51) Int. Cl. G06F 30/17; G06F 30/20; G06F 119/14

(52) U.S. Cl. CPC G06F 30/17; G06F 30/20; G06F 2119/14

(57) ABSTRACT

Methods, systems, and apparatus, including medium-encoded computer program products, for generating robotic grasps for CAD models. An example method includes: receiving a three-dimensional model of a three-dimensional object; performing grasp sampling on the three-dimensional model to generate candidate grasps for gripper fingers of a robot to grasp the three-dimensional object; performing an evaluation of the candidate grasps by performing a physics-based simulation on each candidate grasp including applying perturbations to each candidate grasp using simulated motion of a virtual robot that grasps the three-dimensional object at the candidate grasp and to move the virtual robot through pre-defined poses of the virtual robot; and selecting grasps for the three-dimensional model of the three-dimensional object, from the candidate grasps, based on a result of the evaluation.

### CROSS-REFERENCE TO RELATED APPLICATIONS

This patent application claims priority to and the benefit of U.S. Provisional Patent Application No. 63/804,486, filed on May 12, 2025, which is incorporated herein by reference in its entirety.

### BACKGROUND

This specification relates to generating training data for training robotic grasping models.

Large datasets have been one of the major contributors to the success of AI models. The fields of Computer Vision and Natural Language Processing have seen tremendous progress due to the presence of internet-scale datasets. Machine learning models, such as generative models, trained on massive datasets demonstrate strong generalization capabilities to tasks that were not part of the training data, due to a diverse training set and novel model architectures.

Robotic grasping refers to the ability of robots to hold and manipulate objects with the robots'gripper fingers or hands. This involves a complex process that includes identifying the object and its pose, determining the best grasp to hold the object, and moving the gripper and applying the necessary force. Robotic grasping is a crucial task in various applications, including manufacturing, industrial automation, logistics, and household tasks. In these various applications, robots are increasingly expected to handle a wide range of objects.

However, robot grasping models trained on limited datasets cannot properly grasp and manipulate novel objects that are not represented in the limited training datasets. In real-world environments such as warehouses or manufacturing plants, the diversity of objects can be vast, and grasping models need to generalize to this diversity. Training large, generalizable robot-grasping models requires a large dataset of geometrically diverse realistic three-dimensional (3D) objects and grasp labels for the geometrically diverse realistic 3D objects.

Obtaining ground truth grasp labels for a large dataset of geometrically diverse 3D objects can be challenging. An expert user can manually generate ground truth grasp labels by putting gripper fingers on desired locations of a three-dimensional model of an object on a user interface of a CAD software. However, labeling a large dataset can be time consuming and sometimes infeasible. Furthermore, it is challenging to generate useful training examples because synthetic data has a realism gap with real data.

A computer-aided design (CAD) model is a digital representation of a physical object created using CAD software. The CAD models can be two-dimensional (2D) or 3D and can be used for various purposes, including design visualization, analysis, and optimization before manufacturing. 3D CAD models can be in various formats, such as solid models (e.g., voxels) or surface models (e.g., B-Rep (Boundary Representation), surface meshes).

### SUMMARY

This specification describes technologies relating to generating robotic grasps for CAD models. In particular, the specification relates to automatically generating accurate ground truth grasp labels for a large dataset of geometrically diverse 3D objects represented as CAD models. The described approach to generating robotic grasps includes grasp sampling to generate candidate grasps, collision checks to filter out grasps that may be in collision with the 3D object, and physics-based evaluation to determine whether the grasp can hold the object firmly under perturbation.

In general, one innovative aspect of the subject matter described in this specification can be embodied in methods that include the actions of receiving a three-dimensional model of a three-dimensional object; performing grasp sampling on the three-dimensional model to generate candidate grasps for gripper fingers of a robot to grasp the three-dimensional object; performing an evaluation of the candidate grasps by performing physics-based simulation on each candidate grasp including applying perturbations to each candidate grasp using simulated motion of a virtual robot that grasps the three-dimensional object at the candidate grasp and to move the virtual robot through pre-defined poses of the virtual robot; and selecting grasps for the three-dimensional model of the three-dimensional object, from the candidate grasps, based on a result of the evaluation.

Performing the grasp sampling includes: generating initial candidate grasps for the three-dimensional model of the three-dimensional object; performing a collision check between the three-dimensional model of the three-dimensional object and a three-dimensional model of the gripper fingers located at each initial candidate grasp; and selecting, as the candidate grasps, the initial candidate grasps that passes the collision check. Performing the evaluation of the candidate grasps includes: setting one or more physical properties of the three-dimensional object, including at least: a mass of the three-dimensional object and a friction coefficient of the three-dimensional object; determining whether the virtual robot continues to grasp the three-dimensional object under the perturbations while the virtual robot moves through the pre-defined poses; and in response to determining that the virtual robot continues to grasp the three-dimensional object under the perturbations while the virtual robot moves through the pre-defined poses, generating the result of the evaluation indicating that the candidate grasp is a successful grasp. The virtual robot includes virtual gripper fingers and an arm that connects to and moves the virtual gripper fingers.

Each candidate grasp includes a grasp pose, and performing the grasp sampling includes: identifying multiple sets of contact points on a surface of the three-dimensional model of the three-dimensional object; and for each set of contact points, determining the grasp pose including fitting the gripper fingers on the set of contact points at a plurality of orientations around the three-dimensional object. Performing the grasp sampling includes: generating a decimated three-dimensional model by performing mesh decimation on the three-dimensional model of the three-dimensional object; and performing the grasp sampling using the decimated three-dimensional model of the three-dimensional object. The actions include: performing clustering on the candidate grasps to generate representative candidate grasps, wherein a number of the representative candidate grasps is less than a number of the candidate grasps; performing the evaluation of the representative candidate grasps; and selecting the grasps for the three-dimensional model of the three-dimensional object, from the representative candidate grasps, based on the result of the evaluation of the representative candidate grasps.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Particular embodiments of the subject matter described in this specification can be implemented to realize one or more of the following advantages.

Previously, it was not feasible to train large robot grasping models that have complex architectures and many parameters because of the limited availability of robotic grasp datasets, especially the limited availability of the grasp labels. The systems and techniques can automatically generate accurate grasp labels for a large dataset of geometrically diverse and realistic 3D objects. Thus, large robot grasping models can be trained on the large dataset of geometrically diverse and realistic 3D objects with the grasp labels. Once trained, the large robot grasping models can be used in industrial applications to handle a wide range of objects in simulated and real-world settings.

In some systems, grasp fingers at proposed grasp points may collide with the 3D object, especially for concave objects. Rather than generating grasp labels that may collide with the geometry of the 3D object, the systems and techniques can take into consideration of the geometry of the gripper fingers of the robot and can perform collision checking on candidate grasps to make sure the grasp fingers can fit with the geometry of the 3D object. In some implementations, the systems and techniques can perform the collision checking by checking whether a mesh representation of the grasp finger collides with a mesh representation of the 3D object.

To determine physical feasibility of the candidate grasps, the systems and techniques described perform a physics-based simulation. Rather than only performing simple movement simulations in a few axes, the systems and techniques can model frictions and properties of the 3D object and can introduce external moments on the 3D object by moving the object in different directions and/or from a starting location to a target location. The systems and techniques can observe if the robot gripper can continue to hold the object firmly under external forces and perturbations that simulate real-world manipulation. Rather than using only gripper fingers (e.g., without a robot arm) in the physics-based simulation, the systems and techniques use a whole robot arm to pick up the object and move to a target location in order to simulate the real-world scenario and to determine whether the candidate grasps are kinematically feasible.

In some implementations, the systems and techniques can perform massive paral-lelization of the physics-based simulation on hundreds or thousands of 3D objects to efficiently identify the suitable grasp labels for the 3D objects. In some implementations, the systems and techniques can perform clustering on candidate grasps to generate a diverse set of grasps for the physics-based simulation. Because the physics-based simulation is computationally intensive, through clustering, the systems and techniques can reduce the computation cost to avoid checking grasp points that are close to one another.

Rather than randomly picking an orientation of the gripper, the systems and techniques can generate grasps from multiple sampled orientations of the gripper for each set of contact points, thus increasing the variety of possible grasp poses in the grasp labels. Some systems generate grasp labels at a fixed decimation level of 3D models, and this may result in inappropriate grasps (e.g., grasp points on a sharp edge of a gear). Rather than generating the grasp labels at a fixed decimation level of the 3D models of the 3D objects, the systems and techniques can generate, as needed, a decimated 3D model by performing mesh decimation on a 3D (mesh) model of a 3D object, and can perform grasp sampling using the decimated 3D model. For example, mesh decimation can result in a reduction of triangle counts in a mesh. Thus, the systems and techniques can generate better grasp points and can fit the gripper fingers at grasp points on flat surfaces instead of on edges.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system usable to generate robotic grasps for CAD models.

FIG. 2 is a flowchart showing an example of a process to generate robotic grasps for CAD models.

FIGS. 3A-3B is an example of a collision check.

FIG. 4 is an example of a simulation environment including a single robot executing a candidate grasp.

FIG. 5 is an example of a simulation environment including multiple robots executing candidate grasps.

FIG. 6 is an example of a stable grasp.

FIG. 7 is an example of an unstable grasp.

FIG. 8 is a schematic diagram of a data processing system including a data processing apparatus, which can be programmed as a client or as a server.

Like reference numbers and designations in the various drawings indicate like elements.

### DETAILED DESCRIPTION

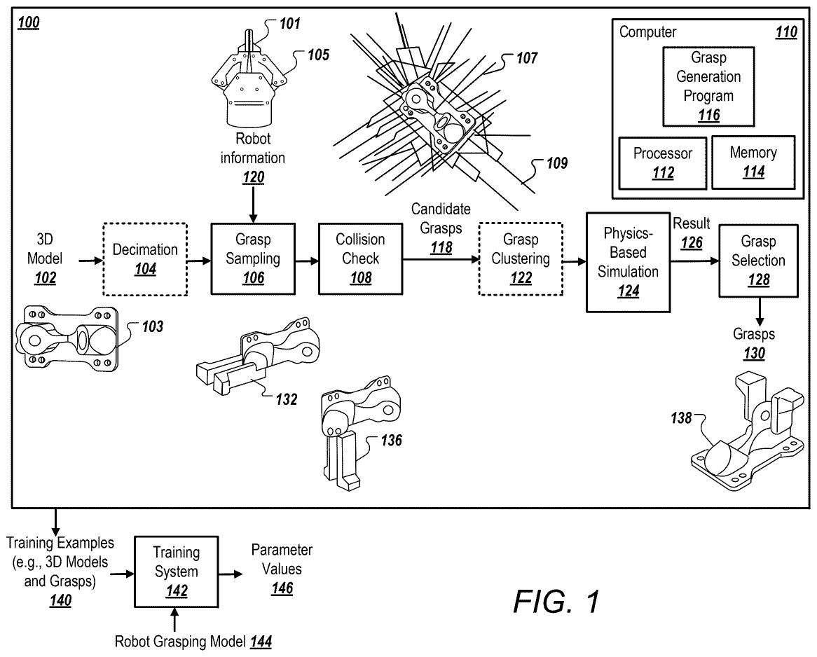

FIG. 1 shows an example of a system 100 usable to generate robotic grasps for CAD models. A robot 105 can use its gripper, e.g., gripper fingers 101, to hold and manipulate an object. Grasps (also called “grasp labels”) define how a robot interacts with an object to achieve a successful grasp of the object. A grasp can include parameters that define grasp pose (e.g., gripper orientation), gripper width, and contact points with the object. After grasping the object, the robot can move and manipulate the object.

The system 100 receives a 3D model 102 of a 3D object 103. The 3D object 103 can be of any shapes or materials. The 3D model 102 can be a 3D CAD model. The 3D model 102 can be in various formats, such as solid models (e.g., voxels) or surface models (e.g., B-Rep (Boundary Representation) or surface meshes). For example, the 3D model 102 can include a 3D surface mesh that represents the surfaces, e.g., including curved surfaces, of the 3D object 103 using a collection of interconnected polygons. The polygons can, for example, be triangles or quadrilaterals. Although FIG. 1 illustrates the process of generating grasps (e.g., grasp labels) for one 3D model 102, the system 100 can be used to automatically generate accurate grasp labels for a large dataset of geometrically diverse and realistic 3D objects.

The system 100 performs grasp sampling 106 on the 3D model 102 to generate candidate grasps 118 for gripper fingers 101 of a robot 105 to grasp the 3D object 103. Grasp sampling 106 is the process of generating many potential grasps for a robot to hold an object. During the grasp sampling 106, the system 100 can randomly sample grasp parameters to create a diverse set of candidate grasps 118. The grasp parameters can include, for example, grasp pose (e.g., gripper orientation), gripper width, and contact points.

For example, the system 100 can generate hundreds or thousands of candidate grasps 118 for the 3D model 102 of the 3D object 103. The images 132, 136, and 138 show the gripper fingers 101 at three different candidate grasps 118 holding the 3D object 103. The image 107 shows a representation of a set of candidate grasps 118. The candidate grasps 118 include grasps at various grasp poses (e.g., grasp orientations), various gripper widths, and various contact points with the 3D object 103. For example, the label 109 represents one candidate grasp that holds the 3D object 103 on a corner of the 3D object 103.

The system 100 can obtain robot information 120 for the robot that is used to grasp the 3D objects. In some implementations, the robot information 120 can include a number of gripper fingers 101 for the robot, e.g., a two-finger gripper or a three-finger gripper, a dimen-sion of the gripper fingers 101, or other relevant configuration of the robot. For example, the robot information 120 can indicate that the fingers 101 has parallel-jaw grasp with six degrees of freedom (6-DoF) for the movement of the gripper fingers 101. In some implementations, the system 100 can generate the candidate grasps 118 for the 3D model 102 using the robot information 120.

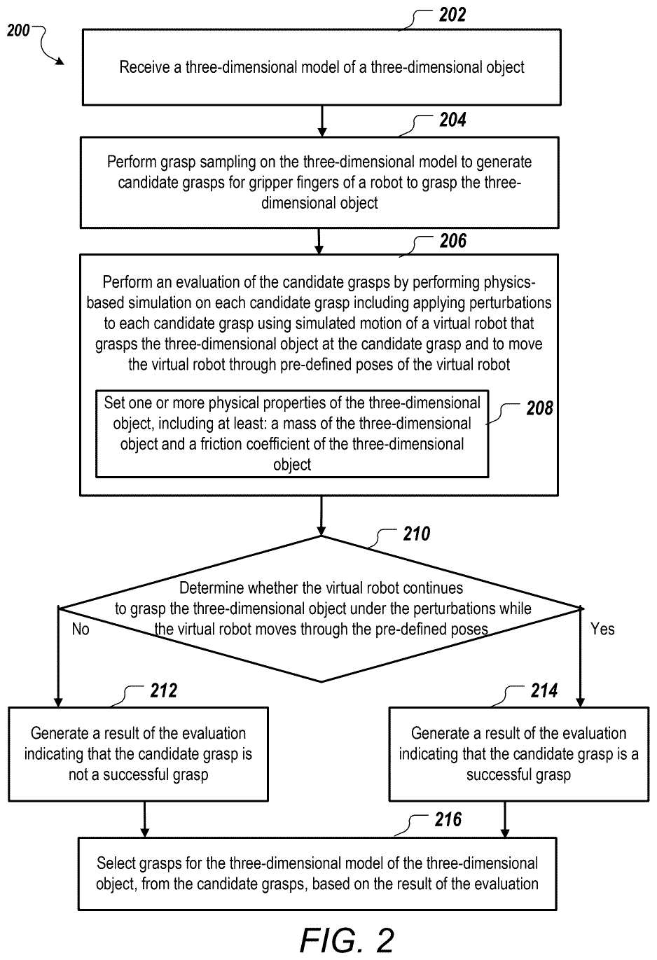

The system 100 can use any suitable grasp sampling techniques to generate the candidate grasps 118. Example grasp sampling techniques include uniform samplers (e.g., S. M. LaValle. Planning Algorithms. Cambridge University Press, Cambridge, U.K., 2006. Available at http://planning.cs.uiuc.edu/), approach-based samplers (e.g., Matthew Veres, Medhat Moussa, and Graham W Taylor. An integrated simulator and dataset that combines grasping and vision for deep learning. arXiv preprint arXiv: 1702.02103, 2017), antipodal-based samplers (e.g., Andreas ten Pas and Robert Platt. Using geometry to detect grasps in 3d point clouds. arXiv preprint arXiv: 1501.03100, 2015), or analytical approaches (e.g., Xiangyang Zhu and Jun Wang. Synthesis of force-closure grasps on 3-D objects based on the Q distance. IEEE Transactions on robotics and Automation, 19(4):669-679, 2003). An example implementation using an antipodal-based grasp sampler is described herein in connection with FIG. 2.

In some systems, grasp fingers at proposed grasp points may collide with the 3D object, for example, for concave objects. The system 100 can take into consideration the geometry of the gripper fingers of the robot and can perform collision check 108 on the generated grasps to make sure that the grasp fingers can fit with the geometry of the 3D object. In some implementations, the system 100 can generate initial candidate grasps for the 3D model 102 of the 3D object 103. In some implementations, the system 100 can perform a collision check 108 between the 3D model 102 of the 3D object 103 and a 3D model of the gripper fingers 101 located at each initial candidate grasp.

The system 100 can perform the collision check 108 to determine whether the gripper fingers 101 of the robot 105 using the initial candidate grasps collides with the 3D model 102 of the 3D object 103. For example, the system 100 can perform collision checks 108 between the gripper fingers 101 in sampled grasp poses and the object's CAD model. In some implementations, the system 100 can select, as the candidate grasps 118, the initial candidate grasps that passes the collision check 108. Through the collision check, the system 100 can remove initial candidate grasps where the geometry of the gripper fingers 101 collides with the 3D object 103.

In some implementations, the system 100 can obtain robot information 120 for the robot that is used to grasp the 3D objects. The robot information 120 can include geometry information for the gripper fingers 101. For example, the geometry information can include thickness of the gripper fingers or dimensions of the gripper fingers. The system 100 can use the robot information 120 to perform the collision check 108.

For example, each candidate grasp 118 can include parameters that define a set contact points and gripper orientation for the gripper fingers 101 of the robot 105. The system 100 can perform collision check 108 to determine whether the system 100 can fit the gripper fingers 101 between the contact points without colliding with the 3D object 103. For example, when an object has a concave shape, the gripper fingers using an initial candidate grasp may collide with the 3D object.

In some implementations, the system 100 can perform the collision check 108 by checking whether a mesh representation of the grasp finger collides with a mesh representation of the 3D object. In some implementations, the system 100 can perform the collision check 108 by determining whether a mesh representation for the gripper fingers 101 using an initial candidate grasp collides with the 3D model 102 that includes a mesh representation of the 3D object 103. If the mesh representation for the gripper fingers 101 collides with the mesh representation of the 3D object 103, the system 100 can determine that the initial candidate grasp is not a suitable candidate grasp. The system 100 can exclude the initial candidate grasp from the set of the candidate grasps 118. If the mesh representation for the gripper fingers 101 does not collide with the mesh representation of the 3D object 103, the system 100 can determine that the initial candidate grasp is a suitable candidate grasp. The system 100 can include the initial candidate grasp in the set of the candidate grasps 118.

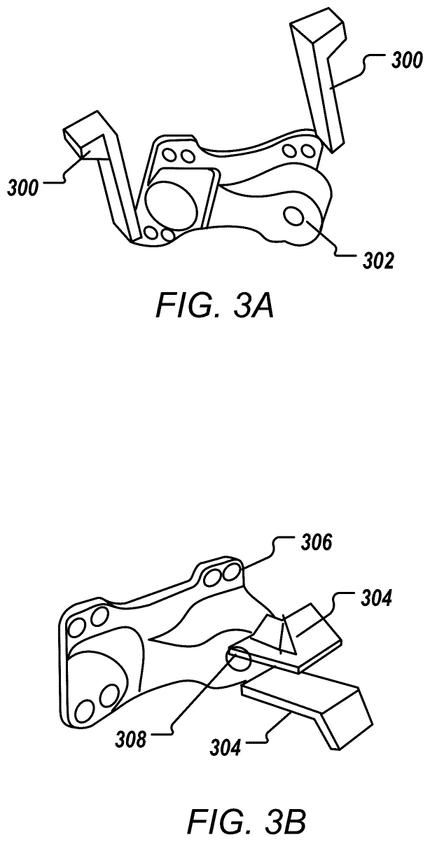

FIGS. 3A-3B is an example of a collision check 108. In FIG. 3A, the gripper fingers 300 using a first initial candidate grip is at the outer edges of the 3D model 302. The system 100 can perform the collision check 108 to determine that the gripper fingers 300 using the first initial candidate grip does not collide with the 3D model 302. The system 100 can include the first initial candidate grip in the set of candidate grasps 118. In FIG. 3B, one contact point for a second candidate grip is inside an inner cylinder 308 of the 3D model 306. Because the diameter of the inner cylinder 308 is relatively small, the gripper fingers 304 cannot fit into the cylinder. The system 100 can perform the collision check 108 and can determine that the gripper fingers 304 using the second initial candidate grip collides with the 3D model 306. The system 100 can exclude the second initial candidate grip from the set of candidate grasps 118.

Referring to FIG. 1, to determine physical feasibility of the candidate grasps, the system 100 can perform a physics-based simulation 124. The system 100 can perform an evaluation of the candidate grasps 118 to determine robustness of the candidate grasps 118 under external perturbations. In some implementations, the system 100 can perform the physics-based simulation 124 on each candidate grasp 118. The system 100 can use any suitable physics-based simulator to perform the physics-based simulation 124. Example physics-based simulators include FleX physics simulator (e.g., Miles Macklin, Matthias Müller, Nuttapong Chentanez, and Tae-Yong Kim. Unified particle physics for realtime applications. ACM Trans. Graph., 33(4), July 2014. ISSN 0730-0301.doi: 10.1145/2601097.2601152. URL https://doi.org/10.1145/2601097.2601152), or Isaac Sim simulator (e.g., NVIDIA Corporation. NVIDIA Isaac Sim, 2023. URL https://developer.nvidia.com/isaac-sim. Version 2023.1).

In some implementations, the system 100 can introduce external moments on the 3D object by moving the object in different directions and/or from a starting location to a target location. The system 100 can observe if the robot gripper can continue to hold the object firmly under external forces and perturbations that simulate real-world manipulation.

In some implementations, the system 100 can apply perturbations to each candidate grasp 118 using simulated motion of a virtual robot that grasps the 3D object 103 at the candidate grasp 118. In some implementations, the virtual robot can be configured to simulate the robot 105 having the gripper fingers 101. In some implementations, the simulated motion of the virtual robot can move the virtual robot through pre-defined poses of the virtual robot, e.g., from a starting position in an environment to a destination position in the environment. In some implementations, the simulated motion of the virtual robot can include translation and rotation in a simulated 3D space at various velocities and accelerations.

In some implementations, the system 100 can model frictions and properties of the 3D object. In some implementations, the system 100 can set one or more physical properties of the 3D object 103. In some implementations, the one or more physical properties of the 3D object 103 can include at least: a mass of the 3D object 103, a friction coefficient of the 3D object 103, or a combination of both.

In some implementations, the system 100 can determine physical parameters of the simulation using the one or more physical properties of the 3D object 103. Thus, using the one or more physical properties of the 3D object 103, the physics-based simulator can generate a result of a candidate grasp under the simulated perturbations and/or the simulated motions.

In some implementations, the system 100 can determine whether the virtual robot continues to grasp the 3D object 103 under the perturbations while the virtual robot moves through the pre-defined poses. In some implementations, if the virtual robot can continue to grasp the 3D object under perturbations while the virtual robot moves through the pre-defined poses, the candidate grasp is a stable grasp. In some implementations, if the virtual robot cannot continue to grasp the 3D object under perturbations while the virtual robot moves through the pre-defined poses, the candidate grasp is an unstable grasp.

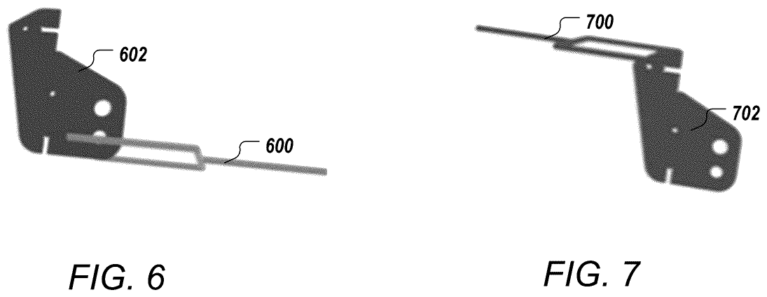

FIG. 6 is an example of a stable grasp 600 for a 3D model 602. The grasp 600 is stable because the grasp 600 is on the center of the object. FIG. 7 is an example of an unstable grasp 700 for a 3D model 702. The grasp 700 is unstable because the grasp 700 is on the edge of the object.

The system 100 can perform grasp selection 128 to select grasps 130 for the 3D model 102 of the 3D object 103, from the candidate grasps 118, based on a result 126 of the evaluation. For example, the system 100 can select the stable candidate grasps as the grasps 130 for the 3D model 102. For example, the image 138 shows an example of a stable grasp that holds the object 103 at a grasp pose and contact points that can survive the simulated perturbations and/or the simulated motions.

Based on the evaluation, the system can designate some grasps as successful grasps. In some implementations, in response to determining that the virtual robot continues to grasp the 3D object 103 under the perturbations while the virtual robot moves through the pre-defined poses, the system 100 can generate the result 126 of the evaluation indicating that the candidate grasp is a successful grasp, e.g., a stable grasp. In some implementations, the system 100 can select, as the grasps 130 for the 3D model 102 of the 3D object 103, from the candidate grasps 118, based on the result 126 indicating that the grasps 130 are successful grasps.

In some implementations, in response to determining that the virtual robot does not continue to grasp the 3D object 103 under the perturbations while the virtual robot moves through the pre-defined poses, the system 100 can generate the result 126 of the evaluation indicating that the candidate grasp is an unsuccessful grasp, e.g., an unstable grasp. For example, the grasp shown in image 136 can be an unstable grasp that might not survive the simulated perturbations and/or the simulated motions.

A robot grasping model 144 can include one or more algorithms that a robot can use to understand the shape and position of an object and then plan and execute a grasping action. In some implementations, the robot grasping model 144 can be a machine learning model that can be trained on training data. In some implementations, the machine learning model can include a neural network model that includes a large number of parameters. For example, a diffusion based grasping model (e.g., Julen Urain, Niklas Funk, Jan Peters, and Georgia Chalvatzaki. Se(3)-diffusionfields: Learning smooth cost functions for joint grasp and motion optimization through diffusion. In 2023 IEEE International Conference on Robotics and Automation (ICRA), pages 5923-5930. IEEE, 2023) can include thousands or mil-lions of parameters. The values for the parameters can be determined through the training of the machine learning model. Training large, generalizable robot-grasping models requires geometrically diverse training datasets.

The system 100 can produce training data that can be used to train the robot grasping model 144. The training data can include a plurality of training examples 140. Each training example 140 can include a 3D model and grasps for the 3D model. For example, a training example 140 can include the 3D model 102 of the 3D object 103 and the grasps 130 for the 3D model 102. In some implementations, a training system 142 can train the robot grasping model 144 on the training examples 140. After the training is completed, the training system 142 can determine values 146 for the parameters of the robot grasping model 144.

Because the system 100 can automatically generate accurate (and stable) grasp labels for a large dataset of geometrically diverse and realistic 3D objects, a robot grasping model 144 (e.g., a model with lots of parameters) can be trained on the large dataset of geometrically diverse and realistic 3D objects with the grasp labels. Once trained, the robot grasping model 144 can be used in various applications, (e.g., industrial applications) to handle a wide range of objects in simulated and real-world settings.

The system 100 can be implemented in a computer 110. The computer 110 includes a processor 112 and a memory 114, and the computer 110 can be connected to a network (not shown), which can be a private network, a public network, a virtual private network, etc. The processor 112 can be one or more hardware processors, which can each include multiple processor cores. The processor 112 can include central processing units (CPUs) and graphics processing units (GPUs) that are used to process data using a machine learning model. The memory 114 can include both volatile and non-volatile memory, such as Random Access Memory (RAM) and Flash RAM. The computer 110 can include various types of computer storage media and devices, which can include the memory 114, to store instructions of programs that run on the processor 112, including a grasp generation program 116. The grasp generation program 116 can generate grasps 130 for CAD models 102, as dis-cussed herein in connection with FIG. 1 and FIG. 2. In some implementations, the computer 110 can store CAD program(s) in the memory 114. The CAD program(s) can generate the 3D model 102 (e.g., a CAD model) for the 3D object 103.

The grasp generation program 116 can run locally on computer 110, remotely on a computer of one or more remote computer systems (e.g., one or more third party providers'one or more server systems accessible by the computer 110 via the network) or both locally and remotely. Thus, the grasp generation program 116 can be two or more programs that op-erate cooperatively on two or more separate computer processors in that a program operating locally at computer 110 can offload processing operations “to the cloud” by having one or more programs on one or more remote computer systems perform the offloaded processing operations. For example, the system 100 can offload the physics-based simulation 124 to the cloud by having one or more remote computer systems perform the physics-based simulation 124, which may require lots of computation resources. In some implementations, the grasp generation program 116 can present a user interface (UI) on a display device of the computer 110, which can be operated using one or more input/output devices of the computer 110 (e.g., keyboard and mouse). For example, the grasp generation program 116 can display the candidate grasps 118 and/or the grasps 130 on the UI of the display device of the computer 110.

FIG. 2 is a flowchart showing an example of a process 200 to generate robotic grasps for CAD models. The example process 200 can be performed by one or more components of a grasp label generation system, e.g., the system 100. The example process 200 will be described as being performed by the system 100, programmed appropriately in accordance with this specification.

The system can receive (202) a 3D model of a 3D object. For example, the 3D model can be a CAD model, e.g., a 3D (surface) mesh of a 3D object. In some implementations, the system can generate a decimated 3D model by performing mesh decimation, e.g., decimation 104 of FIG. 1, on the 3D model of the 3D object. Decimation 104 is the process of reducing the sampling rate of a mesh, e.g., downsampling the mesh. Decimation 104 can result in mesh surfaces with polygons that have larger area, reducing the likelihood of having sharp edges in the surface mesh. Thus, the system can more easily fit gripper fingers on the mesh of the 3D object. In some implementations, the system can perform the grasp sampling using the decimated 3D model of the 3D object.

For example, rather than generating the grasp labels at a fixed decimation level of the 3D models of the 3D objects, the system can generate, as needed, a decimated 3D model by performing mesh decimation on a 3D (mesh) model of a 3D object, and can perform grasp sampling using the decimated 3D model. For example, mesh decimation can result in a reduction of triangle counts in a mesh. Thus, the systems and techniques can generate better grasp points and can fit the gripper fingers at grasp points on flat surfaces instead of on edges.

The system can perform (204) grasp sampling on the 3D model to generate candidate grasps for gripper fingers of a robot to grasp the 3D object. For example, the system can use a grasp sampler to process an input to the grasp sampler. In some implementations, the input can include a mesh of the 3D object, a decimated mesh of the 3D object, or both. In some implementations, the input can include a CAD model and a decimation factor.

In some implementations, the system can obtain a CAD model that is watertight. For example, the CAD model can be generated using a watertight manifold surface generation method (e.g., Jingwei Huang, Hao Su, and Leonidas Guibas. Robust watertight manifold surface generation method for shapenet models. arXiv preprint arXiv:1802.01698, 2018).

In some implementations, given a CAD model for an object, the system can utilize an antipodal sampling method to sample grasps. For example, using the antipodal sampling method, the system can sample points on a mesh surface included in the CAD model of the object. The system can compute the surface normal for the points. The system can cast three rays within a cone aligned with the surface normal. The cone can have a predetermined cone angle. For example, the vertex angle of the cone can be 30 degrees, 35 degrees, or 40 degrees. The system can identify the points on the CAD model that these rays intersect. The system can select the points whose surface normal is in the opposite direction of the ray ori-gin's surface normal because these points can represent potential antipodal contact points. Antipodal points are two points on a sphere that are opposite through the center of the sphere. The system can determine the gripper pose by aligning the fingers'surface normal with the line connecting these antipodal points. For example, the z-axis of the gripper can be aligned with four uniformly spaced vectors, each 90 degrees apart, around this line.

For example, the system can perform the grasp sampling using an antipodal sampling method. For each point p on the CAD model M, the system can perform the following. The system can compute a surface normal \hat{n} at the point p. The system can cast rays within a 30-degree cone aligned with the surface normal \hat{n}. The system can find antipodal points (p₁, p₂) satisfying \hat{n}₁·\hat{n}₂=−1. Thus, using the antipodal sampling method, the system can generate candidate grasps. Each candidate grasp includes a grasp pose

$$\{ {}_{o}^{◻} {T}_{g} \}$$

and a gripper width {g_{w}} in mm.

In some implementations, each candidate grasp can include a grasp pose. The system can identify multiple sets of contact points on a surface of the 3D model of the 3D object. In some implementations, for each set of contact points, determining the grasp pose can include fitting the gripper fingers on the set of contact points at a plurality of orientations around the 3D object. Thus, rather than randomly picking an orientation of the gripper, the system can generate grasps from multiple sampled orientations of the gripper for each set of contact points, thus increasing the variety of possible grasp poses in the grasp labels. For example, for each pair of antipodal points (p₁, p₂), the system can determine multiple grip pose, e.g., orientations around the 3D object, such as gripping the object from the left side, the right side, the front, the back, the top, and the bottom.

In some implementations, the system can generate initial candidate grasps for the 3D model of the 3D object. In some implementations, the system can perform a collision check between the 3D model of the 3D object and a 3D model of the gripper fingers located at each initial candidate grasp. In some implementations, the system can select, as the candidate grasps, the initial candidate grasps that pass the collision check.

For example, the system can align the fingers with the points (p₁, p₂), with the gripper's z-axis spaced 90-degrees apart. If there is no collision between the fingers and the 3D object, the system can add the initial candidate grasp

$$( {}_{o}^{◻} {T}_{g} , {g}_{w} )$$

into the list of candidate grasps. More details for collision check 108 are described in connection with FIG. 1.

In some implementations, the system can find better grips by performing mesh decimation, e.g., decimation 104 of FIG. 1. In some implementations, the system can decimate the CAD model M by a factor d and can repeat the antipodal sampling process described herein on the decimated mesh. For example, the system can decimate the CAD model by a factor of 0.6, 0.61, or 0.59, and repeat the grasp sampling process described herein. For example, a mesh decimation factor of 0.6 can preserve the underlying shape of the mesh while also increasing the number of potential graspable surfaces. A graspable surface on a mesh is a collection of polygons (e.g., triangles) that come in contact with the finger grasping the object.

The system performs (206) an evaluation of the candidate grasps by performing a physics-based simulation on each candidate grasp including applying perturbations to each candidate grasp using simulated motion of a virtual robot that grasps the 3D object at the candidate grasp and to move the virtual robot through pre-defined poses of the virtual robot. More details for the physics-based simulation 124 are described in connection with FIG. 1.

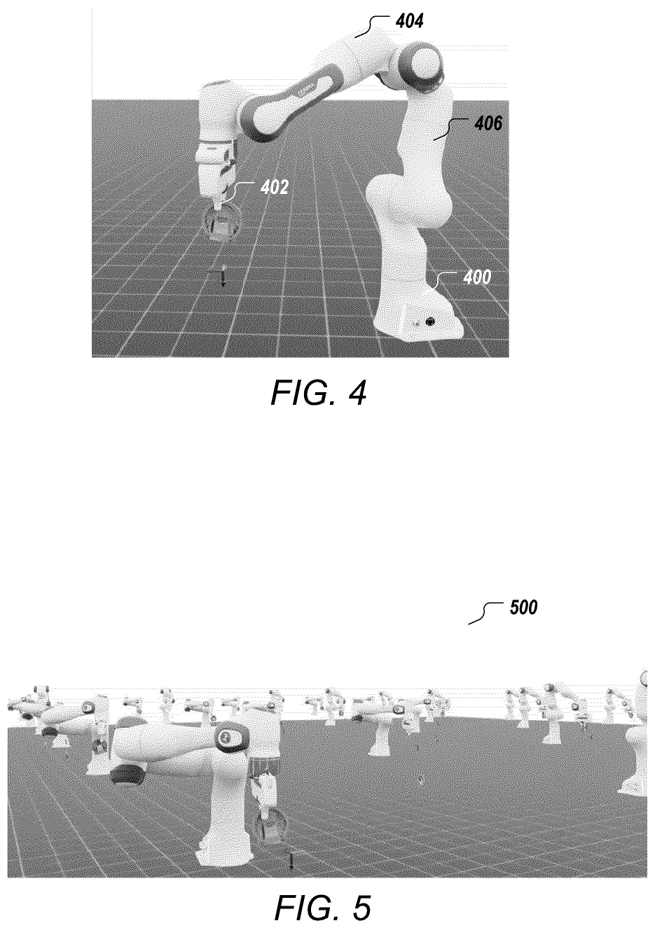

In some implementations, the virtual robot can include virtual gripper fingers and an arm that connects to and moves the virtual gripper fingers. FIG. 4 is an example of a simulation environment including a single robot 400 executing a candidate grasp. The robot 400 includes virtual gripper fingers 402 and an arm 404 and 406 that connects to and moves the virtual gripper fingers 402. Rather than using only gripper fingers (e.g., without a robot arm) in the physics-based simulation, the system can use a whole robot arm to pick up the object and move to a target location in order to simulate the real-world scenario and to determine whether the candidate grasps are kinematically feasible.

In some implementations, the systems and techniques can perform massive paral-lelization of the physics-based simulation on hundreds or thousands of 3D objects and/or their candidate grasps to efficiently identify the suitable grasp labels for the 3D objects. FIG. 5 is an example of a simulation environment 500 including multiple robots executing candidate grasps. For example, for 2000 candidate grasps, the system can use 2000 robots in the simulated environment to test each candidate grasps in parallel.

In some implementations, the system can set (208) one or more physical properties of the 3D object, including at least: a mass of the 3D object and a friction coefficient of the 3D object. The system can perform the physics-based simulation using the one or more physical properties of the 3D object.

In some implementations, the system can determine (210) whether the virtual robot continues to grasp the 3D object under the perturbations while the virtual robot moves through the pre-defined poses. In some implementations, in response to determining that the virtual robot continues to grasp the 3D object under the perturbations while the virtual robot moves through the pre-defined poses, the system can generate (214) the result of the evaluation indicating that the candidate grasp is a successful grasp.

For example, for each candidate grasp in the set of candidate grasps, the system can position the 3D object in the simulation environment such that the z-axis of the candidate grasp pose of the candidate grasp is aligned with the world z-axis. The system can move the virtual robot to the candidate grasp pose and then close the gripper fingers. The system can apply perturbations to test the robustness of the candidate grasp. The system can record the evaluation result, such as success, failure, or contact duration with the object by the fingers. For example, the system can record grasps that are in contact with the fingers during the en-tire simulation, contact forces exerted on each object, and for the failed ones, duration of contact.

In some implementations, in response to determining that the virtual robot does not continue to grasp the 3D object under the perturbations while the virtual robot moves through the pre-defined poses, the system can generate (212) the result of the evaluation indicating that the candidate grasp is not a successful grasp.

The system selects (216) grasps for the 3D model of the 3D object, from the candidate grasps, based on a result of the evaluation. For example, the system can select the successful grasps, e.g., the stable grasps, as the grasp labels for the 3D object. The system can generate an output for the grasps, including parameter values for the grasp poses, grasp widths, and contact points.

In some implementations, the system can perform clustering, e.g., grasp clustering 122 of FIG. 1, on the candidate grasps to generate representative candidate grasps. Because the physics-based simulation is computationally intensive, through clustering, the system can reduce the computation cost to avoid checking grasp points that are close to one another. For example, the system can perform clustering 122 on candidate grasps to generate a diverse set of grasps for the physics-based simulation. The number of the representative candidate grasps is less than the number of the candidate grasps. In some implementations, the system can perform the evaluation of the representative candidate grasps. In some implementations, the system can select the grasps for the 3D model of the 3D object, from the representative candidate grasps, based on the result of the evaluation of the representative candidate grasps.

For example, there can be 5,000 to 10,000 candidate grasps 118. The system can apply an Agglomerative Hierarchical clustering algorithm on the candidate grasps 118. The Agglomerative Hierarchical clustering algorithm may not require specifying the number of clusters and can capture complex cluster shapes. For example, in the Agglomerative Hierarchical clustering algorithm, the distance d between two grasps g₁ and g₂ can be defined as:

d=∥t₁−t₂∥+arccos(|q₁·q₂|).

Here, t₁ and t₂ are the translation orientation of g₁ and g₂, respectively. The orientation of g₁ and g₂ are represented as unit quaternions, q₁ and q₂, respectively. The system can select a predetermined number, e.g., 2,000, representative candidate grasps, e.g., using the distances d calculated using the Agglomerative Hierarchical clustering algorithm. The system can perform the physics-based simulation using the representative candidate grasps to save computation resources.

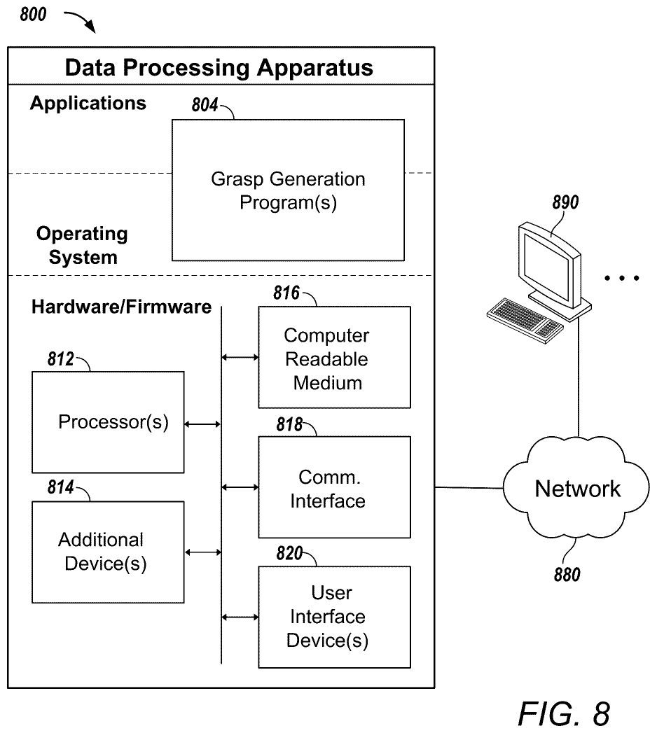

FIG. 8 is a schematic diagram of a data processing system including a data processing apparatus 800, which can be programmed as a client or as a server. The data processing apparatus 800 is connected with one or more computers 890 through a network 880. While only one computer is shown in FIG. 8 as the data processing apparatus 800, multiple computers can be used. The data processing apparatus 800 includes various software modules, which can be distributed between an application layer and an operating system. These can include executable and/or interpretable software programs or libraries, including grasp generation program(s) 804 that implement the systems and techniques described herein. Thus, the grasp generation program(s) 804 can be program(s) that generates grasp labels for CAD models. In some implementations, the executable and/or interpretable software programs or libraries can include tools and services of one or more 2D or 3D program(s) that implement the systems and techniques described herein. The one or more 2D or 3D program(s) can include design, modeling, graphic editing, and computer animation programs and applications. The number of software modules used can vary from one implementation to another. Moreover, the software modules can be distributed on one or more data processing apparatus connected by one or more computer networks or other suitable communication networks.

The data processing apparatus 800 also includes hardware or firmware devices including one or more processors 812, one or more additional devices 814, a computer readable medium 816, a communication interface 818, and one or more user interface devices 820. Each processor 812 is capable of processing instructions for execution within the data processing apparatus 800. In some implementations, the processor 812 is a single or multi-threaded processor. Each processor 812 is capable of processing instructions stored on the computer readable medium 816 or on a storage device such as one of the additional devices 814. The data processing apparatus 800 uses the communication interface 818 to communicate with one or more computers 890, for example, over the network 880. Examples of user interface devices 820 include a display, a camera, a speaker, a microphone, a tactile feedback device, a keyboard, a mouse, and VR and/or AR equipment. The data processing apparatus 800 can store instructions that implement operations associated with the program(s) described above, for example, on the computer readable medium 816 or one or more additional devices 814, for example, one or more of a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In addition, actions recited in the claims can be performed in a different order and still achieve desirable results.

What is claimed is:

1. A computer-implemented method comprising:
receiving a three-dimensional model of a three-dimensional object;
performing grasp sampling on the three-dimensional model to generate candidate grasps for gripper fingers of a robot to grasp the three-dimensional object;
performing an evaluation of the candidate grasps by performing a physics-based simulation on each candidate grasp including applying perturbations to each candidate grasp using simulated motion of a virtual robot that grasps the three-dimensional object at the candidate grasp and to move the virtual robot through pre-defined poses of the virtual robot; and
selecting grasps for the three-dimensional model of the three-dimensional object, from the candidate grasps, based on a result of the evaluation.

2. The method of claim 1, wherein performing the grasp sampling comprises:
generating initial candidate grasps for the three-dimensional model of the three-dimensional object;
performing a collision check between the three-dimensional model of the three-dimensional object and a three-dimensional model of the gripper fingers located at each initial candidate grasp; and
selecting, as the candidate grasps, the initial candidate grasps that passes the collision check.

3. The method of claim 1, wherein performing the evaluation of the candidate grasps comprises:
setting one or more physical properties of the three-dimensional object, comprising at least: a mass of the three-dimensional object and a friction coefficient of the three-dimensional object;
determining whether the virtual robot continues to grasp the three-dimensional object under the perturbations while the virtual robot moves through the pre-defined poses; and
in response to determining that the virtual robot continues to grasp the three-dimensional object under the perturbations while the virtual robot moves through the pre-defined poses, generating the result of the evaluation indicating that the candidate grasp is a successful grasp.

4. The method of claim 1, wherein the virtual robot comprises virtual gripper fingers and an arm that connects to and moves the virtual gripper fingers.

5. The method of claim 1, wherein each candidate grasp comprises a grasp pose, and performing the grasp sampling comprises:
identifying multiple sets of contact points on a surface of the three-dimensional model of the three-dimensional object; and
for each set of contact points, determining the grasp pose comprising fitting the gripper fingers on the set of contact points at a plurality of orientations around the three-dimensional object.

6. The method of claim 1, wherein performing the grasp sampling comprises:
generating a decimated three-dimensional model by performing mesh decimation on the three-dimensional model of the three-dimensional object; and
performing the grasp sampling using the decimated three-dimensional model of the three-dimensional object.

7. The method of claim 1, comprising:
performing clustering on the candidate grasps to generate representative candidate grasps, wherein a number of the representative candidate grasps is less than a number of the candidate grasps;
performing the evaluation of the representative candidate grasps; and
selecting the grasps for the three-dimensional model of the three-dimensional object, from the representative candidate grasps, based on the result of the evaluation of the representative candidate grasps.

8. A system comprising one or more computers and one or more storage devices storing instructions that when executed by the one or more computers cause the one or more computers to perform operations comprising:
receiving a three-dimensional model of a three-dimensional object;
performing grasp sampling on the three-dimensional model to generate candidate grasps for gripper fingers of a robot to grasp the three-dimensional object;
performing an evaluation of the candidate grasps by performing a physics-based simulation on each candidate grasp including applying perturbations to each candidate grasp using simulated motion of a virtual robot that grasps the three-dimensional object at the candidate grasp and to move the virtual robot through pre-defined poses of the virtual robot; and
selecting grasps for the three-dimensional model of the three-dimensional object, from the candidate grasps, based on a result of the evaluation.

9. The system of claim 8, wherein performing the grasp sampling comprises:
generating initial candidate grasps for the three-dimensional model of the three-dimensional object;
performing a collision check between the three-dimensional model of the three-dimensional object and a three-dimensional model of the gripper fingers located at each initial candidate grasp; and
selecting, as the candidate grasps, the initial candidate grasps that passes the collision check.

10. The system of claim 8, wherein performing the evaluation of the candidate grasps comprises:
setting one or more physical properties of the three-dimensional object, comprising at least: a mass of the three-dimensional object and a friction coefficient of the three-dimensional object;
determining whether the virtual robot continues to grasp the three-dimensional object under the perturbations while the virtual robot moves through the pre-defined poses; and
in response to determining that the virtual robot continues to grasp the three-dimensional object under the perturbations while the virtual robot moves through the pre-defined poses, generating the result of the evaluation indicating that the candidate grasp is a successful grasp.

11. The system of claim 8, wherein the virtual robot comprises virtual gripper fingers and an arm that connects to and moves the virtual gripper fingers.

12. The system of claim 8, wherein each candidate grasp comprises a grasp pose, and performing the grasp sampling comprises:
identifying multiple sets of contact points on a surface of the three-dimensional model of the three-dimensional object; and
for each set of contact points, determining the grasp pose comprising fitting the gripper fingers on the set of contact points at a plurality of orientations around the three-dimensional object.

13. The system of claim 8, wherein performing the grasp sampling comprises:
generating a decimated three-dimensional model by performing mesh decimation on the three-dimensional model of the three-dimensional object; and
performing the grasp sampling using the decimated three-dimensional model of the three-dimensional object.

14. The system of claim 8, the operations comprise:
performing clustering on the candidate grasps to generate representative candidate grasps, wherein a number of the representative candidate grasps is less than a number of the candidate grasps;
performing the evaluation of the representative candidate grasps; and
selecting the grasps for the three-dimensional model of the three-dimensional object, from the representative candidate grasps, based on the result of the evaluation of the representative candidate grasps.

15. A non-transitory computer-readable medium encoding instructions operable to cause data processing apparatus to perform operations comprising:
receiving a three-dimensional model of a three-dimensional object;
performing grasp sampling on the three-dimensional model to generate candidate grasps for gripper fingers of a robot to grasp the three-dimensional object;
performing an evaluation of the candidate grasps by performing a physics-based simulation on each candidate grasp including applying perturbations to each candidate grasp using simulated motion of a virtual robot that grasps the three-dimensional object at the candidate grasp and to move the virtual robot through pre-defined poses of the virtual robot; and
selecting grasps for the three-dimensional model of the three-dimensional object, from the candidate grasps, based on a result of the evaluation.

16. The non-transitory computer-readable medium of claim 15, wherein performing the grasp sampling comprises:
generating initial candidate grasps for the three-dimensional model of the three-dimensional object;
performing a collision check between the three-dimensional model of the three-dimensional object and a three-dimensional model of the gripper fingers located at each initial candidate grasp; and
selecting, as the candidate grasps, the initial candidate grasps that passes the collision check.

17. The non-transitory computer-readable medium of claim 15, wherein performing the evaluation of the candidate grasps comprises:
setting one or more physical properties of the three-dimensional object, comprising at least: a mass of the three-dimensional object and a friction coefficient of the three-dimensional object;
determining whether the virtual robot continues to grasp the three-dimensional object under the perturbations while the virtual robot moves through the pre-defined poses; and
in response to determining that the virtual robot continues to grasp the three-dimensional object under the perturbations while the virtual robot moves through the pre-defined poses, generating the result of the evaluation indicating that the candidate grasp is a successful grasp.

18. The non-transitory computer-readable medium of claim 15, wherein the virtual robot comprises virtual gripper fingers and an arm that connects to and moves the virtual gripper fingers.

19. The non-transitory computer-readable medium of claim 15, wherein each candidate grasp comprises a grasp pose, and performing the grasp sampling comprises:
identifying multiple sets of contact points on a surface of the three-dimensional model of the three-dimensional object; and
for each set of contact points, determining the grasp pose comprising fitting the gripper fingers on the set of contact points at a plurality of orientations around the three-dimensional object.

20. The non-transitory computer-readable medium of claim 15, wherein performing the grasp sampling comprises:
generating a decimated three-dimensional model by performing mesh decimation on the three-dimensional model of the three-dimensional object; and
performing the grasp sampling using the decimated three-dimensional model of the three-dimensional object.
